(19) United States
(12) Patent Application Publication
(10) Pub. No.: US 2025/0336964 A1
(43) Pub. Date: Oct. 30, 2025

(54) LITHIUM IRON PHOSPHATE BATTERY COATED ELECTRODE AND METHOD

(71) Applicant: GM Global Technology Operations LLC, Detroit, MI (US)

(72) Inventors: Samantha Maynard, Birmingham, MI (US); Alexander Kelly, Highland, MI (US); Xin Zhang, Shanghai (CN); Meinan He, Birmingham, MI (US); Fang Dai, Troy, MI (US)

(21) Appl. No.: 18/658,458

(22) Filed: May 8, 2024

(30) Foreign Application Priority Data
Apr. 25, 2024 (CN) 2024105109108

(51) Int. Cl. H01M 4/58; H01M 4/02; H01M 4/04; H01M 4/1391; H01M 10/0525

(52) U.S. Cl. CPC H01M 4/5825; H01M 4/1391; H01M 10/0525; H01M 2004/021; H01M 2004/027; H01M 4/0407; H01M 4/0435; H01M 2300/0025

(57) ABSTRACT

A lithium iron phosphate battery and method for making the battery is provided. The lithium iron phosphate battery includes a lithium iron phosphate (LFP) cathode, a lithium anode, and a liquid electrolyte. The lithium iron phosphate (LFP) cathode has a coating adhered thereto. The coating includes a first material more than 70% by weight and a second material less than 30% by weight. The first material has a mean particle size (D50) of 10 micrometers (μm), and the second material has a mean particle size (D50) of 1 μm. The liquid electrolyte transports positively charged ions between the lithium anode and the LFP cathode. The liquid electrolyte includes between 1.0 and 1.5 M LiPF6 and between 0 and 0.5 M LiFSI.

### CROSS-REFERENCE TO RELATED APPLICATIONS

This application claims the benefit of foreign priority under 35 U.S.C. § 119 of Chinese patent application number 2024105109108, filed on Apr. 25, 2024. The contents of this application are incorporated herein by reference in their entirety.

### INTRODUCTION

The present disclosure relates to a lithium iron phosphate battery, and more particularly, to a coated lithium iron phosphate cathode within the lithium iron phosphate battery.

A lithium battery cell, for example a prismatic battery cell, typically includes a plurality of electrode stacks. Each of the electrode stacks includes at least one negative electrode or anode, which is generally made of graphite, and at least one positive electrode or cathode, which is generally made of lithium cobalt oxide. A separator is positioned between the anode and the cathode and prevents direct contact between the anode and cathode. An electrolyte facilitates ion movement between the anode and the cathode. Lithium battery cells using lithium cobalt oxides have a high energy density, are lightweight, and have a low self-discharge rate. However, they are also sensitive to high temperatures, have a risk of thermal runaway, and a limited lifespan.

While prior art methods and systems attempt to minimize the disadvantages of lithium batteries using lithium cobalt oxide cathodes and may achieve their particular purpose, a need still exists for a new and improved lithium battery cell. Accordingly, a lithium battery cell that maximizes energy capacity is needed.

### SUMMARY

According to several aspects of the present disclosure, a lithium iron phosphate battery is provided. The lithium iron phosphate battery includes a lithium iron phosphate (LFP) cathode, a lithium anode, and a liquid electrolyte. The lithium iron phosphate (LFP) cathode has a coating adhered thereto. The coating includes a first material more than 70% by weight and a second material less than 30% by weight. The first material has a mean particle size (D50) of 10 micrometers (μm), and the second material has a mean particle size (D50) of 1 μm. The liquid electrolyte transports positively charged ions between the lithium anode and the LFP cathode. The liquid electrolyte includes between 1.0 and 1.5 M LiPF6 and between 0 and 0.5 M LiFSI.

In accordance with another aspect of the disclosure, the lithium iron phosphate battery includes a lithium iron phosphate cathode with a thickness range of 80-120 μm.

In accordance with another aspect of the disclosure, the lithium iron phosphate battery includes a lithium iron phosphate cathode with a loading greater than 4.0 mAh/cm².

In accordance with another aspect of the disclosure, the lithium iron phosphate battery includes a lithium iron phosphate cathode with a porosity in a range of 25%-30%.

In accordance with another aspect of the disclosure, the lithium iron phosphate battery includes a first material that is lithium iron phosphate powder.

In accordance with another aspect of the disclosure, the lithium iron phosphate battery includes a second material that is lithium iron phosphate powder.

In accordance with another aspect of the disclosure, the lithium iron phosphate battery includes a lithium anode having a thickness between 5-60 μm.

In accordance with another aspect of the disclosure, the lithium iron phosphate battery includes a liquid electrolyte having a viscosity in a range of 0.3-1.3 centipoise.

In accordance with another aspect of the disclosure, the lithium iron phosphate battery includes a liquid electrolyte having a cyclic carbonate between 10% and 50% by weight.

In accordance with another aspect of the disclosure, the lithium iron phosphate battery has a liquid electrolyte having cyclic carbonate including at least one of ethylene carbonate, fluoroethylene carbonate, difluoro ethylene carbonate, or 3,3,3-trifluoropropylene carbonate.

In accordance with another aspect of the disclosure, the lithium iron phosphate battery has a liquid electrolyte including at least one of acyclic acetate, propionate, or butyrate between 10% and 90% by weight.

In accordance with another aspect of the disclosure, the lithium iron phosphate battery has a liquid electrolyte including at least one of methyl acetate, ethyl acetate, methyl propionate, ethyl propionate, methyl butyrate, methyl butyrate, or ethyl butyrate.

According to several aspects of the present disclosure, a method for producing a lithium iron phosphate battery is provided. The method includes determining a coating formulation for a lithium iron phosphate (LFP) cathode, mixing a slurry, coating the LFP cathode with the slurry, drying the LFP cathode and the slurry to form a coating, and calendering the LFP cathode and the coating. The coating formulation includes a first material more than 70% by weight and a second material less than 30% by weight. The first material has a mean particle size (D50) of 10 μm, and the second material has a mean particle size (D50) of 1 μm. The slurry includes the coating formation and at least one of a binder or a carbon suspension, and the slurry has a solid content of 55% or greater.

In accordance with another aspect of the disclosure, the method includes a lithium iron phosphate cathode having a thickness range between 80-120 μm.

In accordance with another aspect of the disclosure, the method includes a lithium iron phosphate cathode having a loading greater than 4.0 mAh/cm².

In accordance with another aspect of the disclosure, the method includes a lithium iron phosphate cathode having a porosity in a range of 25%-30%.

In accordance with another aspect of the disclosure, the method includes a first material that is lithium iron phosphate powder.

In accordance with another aspect of the disclosure, the method includes a second material that is lithium iron phosphate powder.

According to several aspects of the present disclosure, a method for producing a lithium iron phosphate battery is provided. The method includes determining a coating formulation for a lithium iron phosphate (LFP) cathode; dry mixing a first material, a second material, and conductive carbon to form a dry mix; wet mixing a polymer including polyvinylidene fluoride (PVDF) in N-methyl-2-pyrrolidone (NMP) to form a first wet mix; wet mixing polyvinylidene fluoride (PVDF), multi-walled carbon nanotubes (MWCNT), and N-methyl-2-pyrrolidone (NMP) to form a second wet mix; wet mixing the first wet mix with the second wet mix to form a third wet mix; mixing the dry mix with the third wet mix to form a slurry, wherein the slurry has a solid content of 55% or greater; coating the lithium iron phosphate (LFP) cathode with the slurry; drying the lithium iron phosphate (LFP) cathode; and calendering the lithium iron phosphate (LFP) cathode. The coating formulation includes a first material more than 70% by weight and a second material less than 30% by weight. The first material has a mean particle size (D50) of 10 μm, and the second material has a mean particle size (D50) of 1 μm. The slurry has a solid content of 55% or greater.

In accordance with another aspect of the disclosure, the method includes adding N-methyl-2-pyrrolidone (NMP) to the slurry.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle including a battery pack having a plurality of battery cells, in accordance with the present disclosure.

FIG. 2 is a perspective view illustrating a battery cell disposed within the battery pack shown in FIG. 1, where the battery cell includes at least one electrode stack having a lithium iron phosphate cathode with a coating including a first material and a second material, in accordance with the present disclosure.

FIG. 3 is a flowchart illustrating a method for producing a lithium iron phosphate battery including the coated lithium iron phosphate cathode as shown in FIG. 2, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

Compared with lithium battery cells utilizing current nickel cobalt manganese (NCM) cathodes, a lithium iron phosphate (LFP) cathode exhibits improved thermal stability but has a lower specific capacity. For example, most current LFP cathodes have a loading of 3.25 milliamp hours per square centimeter (mAh/cm²). The LFP battery cell and method disclosed herein have an increased loading up to 4 mAh/cm².

Additionally, the LFP battery cell and method disclosed herein include an electrolyte system with a low viscosity and higher conductivity. The LFP battery cell delivers about 130 milliamp hours per gram (mAh/g) specific capacity under a 3C rate, while a baseline electrolyte only provides about 100 mAh/g specific capacity.

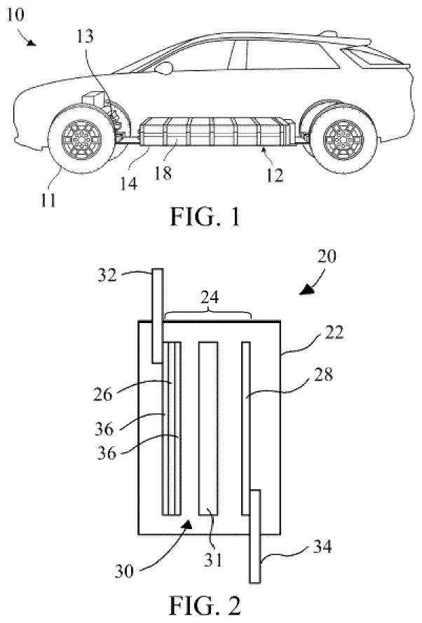

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 11 driven by electric motors/inverters 13. The electric motors/inverters 13 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 14 for supporting a plurality of battery cells 18. In an example, the battery pack 12 may have fifty or more battery cells 18.

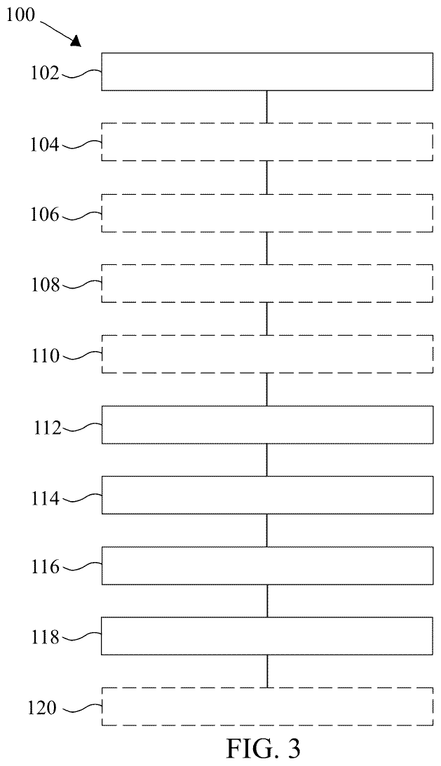

Referring now to FIG. 2, a perspective view illustrates a lithium iron phosphate (LFP) battery 20 disposed within the battery pack 12 shown in FIG. 1, in accordance with an aspect of the present disclosure. Each LFP battery 20 has a housing 22 or case, and at least one electrode stack 24, which includes a lithium iron phosphate (LFP) cathode 26, a lithium anode 28, a liquid electrolyte 30, and a separator 31. Each LFP battery 20 may have tens or hundreds of electrode stacks 24. Each electrode stack 24 is connected to a current collector 32, 34. The electrode stacks are placed in the housing 22 and the housing 22 is filled with a suitable electrolyte 30. Current collectors 32, 34 are thin metal plates or foils disposed, for example, on either side of the electrode stacks 24 and/or housing 22 and typically have a thickness between 0.4 and 1 millimeter. The current collectors 32, 34 may be made of copper or aluminum. The current collectors 32, 34 are attached to the electrode stacks 24 to transmit the electric current to an external circuit (not shown).

Still referring to FIG. 2, the LFP cathode 26 is formed of lithium iron phosphate (LiFePO₄ or “LFP”). Unlike many cathode materials, LFP is a polyanion compound comprised of more than one negatively charged element. LFP atoms are arranged in a crystalline structure forming a 3D network of lithium ions compared to the 2D slabs from nickel manganese cobalt, which is often used in many lithium batteries. Phosphate is beneficial because it is a non-toxic material compared to cobalt oxide or manganese oxide, and LFP batteries are capable of delivering constant voltage at a higher charge cycle. In a specific example, the LFP cathode 26 is between 80 and 120 micrometers (μm) in thickness. Cathode loading is a volume fraction of cathode active material within an electrode mixture. Higher cathode loading generally leads to increased energy density, which is an amount of stored energy per unit volume or mass, within the battery cell. In a specific example, the LFP cathode 26 has a loading greater than 4.0 mAh/cm². Porosity refers to the presence of void spaces or pores within the cathode. Porous cathodes (and electrodes) have high porosity and facilitate efficient transport of ions, such as lithium ions, and other electroactive species. Low porosity can address high electrode density and enhance battery energy density. In a specific example, the LFP cathode 26 has a porosity in a range between 25% to 30% and the electrode density in a range between 2 grams/cubic centimeter (g/cc or g/cm³) to 2.4 g/cc.

The LFP cathode 26 has a coating 36 including lithium particles adhered thereto. The coating 36 can be disposed on multiple sides of the LFP cathode 26 (e.g., a first side that is opposite a second side). The coating 36 includes a first material and a second material each with different particle size distributions. Using a material with only a small particle size (e.g., ˜1 μm) or only a larger particle size (e.g., ˜10 μm) has been found to cause delamination and/or other issues. In some instances, the coating 36 may also be disposed on only one side of the LFP cathode 26.

The coating 36 includes the first material more than 70% by weight (wt. %). The first material is lithium iron phosphate powder with a mean particle size (D50) of 10 μm. The coating 36 also includes the second material less than 30% wt. The second material is lithium iron phosphate powder and has a mean particle size (D50) of 1 μm. Using a combination of the first material and the second material with varying particle size distributions facilitates a coating 36 that is created from a slurry with a high solid content (e.g., >55% solids), which is a critical factor in electrode manufacturing. Additionally, the as-designed cathode 26 withstands more calendaring, addressing both high electrode density and low porosity.

As shown in FIG. 2, the LFP battery 20 includes a lithium anode 28. The lithium anode 28 includes an ultra-thin (e.g., 5-60 micrometers (μm)) lithium anode. A positive charge/current flows into the LFP battery 20 from an external circuit through the lithium anode 28.

Referring to FIG. 2, the electrolyte 30 includes a liquid solution of organic solvents and lithium salts. The liquid electrolyte 30 is a conductive medium for ion transfer between the LFP cathode 26 and the lithium anode 28. The electrolyte 30 facilitates movement of lithium ions during charging and discharging cycles. The electrolyte is low viscosity (e.g., 0.3-1.3 centipoise (cP)). Using a low viscosity liquid electrolyte is beneficial because it generally allows for more rapid molecular movement and collisions, which favors higher reaction rates and provides higher conductivity. In a specific example, the electrolyte 30 includes 1.0-1.5 molar (M) lithium hexafluorophosphate (LiPF₆) and 0-0.5M lithium bis(fluorosulfonyl)imide (LiFSI) as the salt. The electrolyte 30 includes cyclic carbonate (e.g., 10%-50% wt.) as a solid electrolyte interphase (SEI). For example, the electrolyte may be ethylene carbonate, fluoroethylene carbonate, difluoro ethylene carbonate, or 3,3,3-trifluoropropylene carbonate, and the cyclic carbonate having one of the following chemical structures:

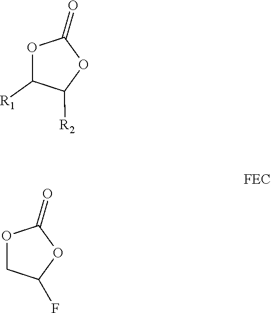

wherein R1, R2 may include a hydrogen atom, an alkyl group, a methoxyl group, a vinyl group, a propargyl group, an alkynyl group, a benzyl group, a hydroxyl group, an alkoxy group, an alkenoxy group, an alkynoxy group, an aryloxy group, a heterocyclyloxy group, a heterocyclyalkoxy group, a silyl group, an siloxy group, an oxo group, a carboxyl group, an ester group, an ether group, a cyano group, a cyanoalkyl group, a fluorine atom, a fluorinated alkyl group, and/or a fluorinated alkoxy group including the formula CₙHₓF_{y} or CH₂CₙHₓF_{y} or CH₂OCHₓF_{y} or CF₂OCₙHₓF_{y}, where group n is 1-5, group m is 1-6, group x is 0-11, and group y is 1-11.

Additionally, the electrolyte 30 may include acyclic acetate, propionate, and/or butyrate (e.g., 10-90% wt.). Some examples may include methyl acetate, ethyl acetate, methyl propionate, ethyl propionate, methyl butyrate, and/or ethyl butyrate including one of the following chemical structures:

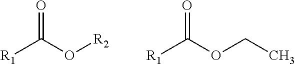

wherein R1, R2 are individually a hydrogen atom, an alkyl, a methoxyl, a vinyl, a propargyl, an alkynyl, a benzyl group, a hydroxyl group, an alkoxy group, an alkenoxy group, an alkynoxy group, an aryloxy group, a heterocyclyloxy group, a heterocyclyalkoxy group, a silyl group, an siloxy group, an oxo group, a carboxyl group, an ester group, an ether group, a cyano group, a cyanoalkyl group, a fluorine atom, a fluorinated alkyl group, and/or a fluorinated alkoxy group including CₙHₓF_{y} or CH₂CₙHₓF_{y} or CH₂OCₙHₓF_{y} or CF₂OCₙHₓF_{y}, where group n is 1-5, group m is 1-6, group x is 0-11, and group y is 1-11.

As shown in FIG. 2, the separator 31 is generally a thin a porous membrane or layer of material that is positioned between the anode 28 and the cathode 26 and prevents the anode 28 and cathode 26 from touching and causing a short circuit. The separator 31 allows the lithium ions to pass through and complete the circuit. A composite material that is porous and chemically stable such as composites made with polyethylene (PE), polypropylene (PP) or other natural materials of the like may be used as the separator 31. Moreover, inorganic nanoparticles such as TiO₂, SiO₂, Al₂O₃, AlO(OH) and ZrO₂ may also be used to create coating composites for the separator 31. Preferably, a thinner, more porous and more conductive separator 31 can lower the resistance and improve performance of the battery 20. The separator 31 is also selected to withstand high temperatures and manage thermal runaway preventing an uncontrollable rise in temperature due to exothermic reactions. Moreover, the separator 31 has a high melting point and a low shrinkage rate to avoid contact between the anode 28 and cathode 26. The separator 31 has sufficient mechanical strength to resist puncture, tear, or deformation during fabrication and operation of battery 20. The separator 31 is chemically inert and compatible with the electrolyte 30, cathode 26, anode 28, and other battery cell components. Additionally, separator 31 has a low affinity for water or other impurities that can contaminate the electrolyte 30 or cause corrosion of the cathode 26 or anode 28.

With reference to FIG. 3, a method 100 for consolidating a foil tab stack of the electrode stack 24 within the battery cell 18 is presented, in accordance with the present disclosure.

The method starts at block 102. Block 102 depicts determining a coating formation for a lithium iron phosphate (LFP) cathode 26. Determining a coating formation can include using a computer processor, for example, to determine an amount of the first material and an amount of the second material. Determining the first material may include determining a percentage of the first material by weight so that the first material is greater than 70% wt. The first material has a mean particle size of 10 μm. Determining the second material may include determining a percentage of the second material by weight so that the second material is less than 30% wt. The second material has a mean particle size of 1 μm. The method 100 may then move to block 104.

Block 104 depicts dry mixing the first material, the second material, and conductive carbon to form a dry mix. The first material, the second material, and the conductive carbon may be mixed using a blender configured for dry powder mixing. Dry mixing may include using the blender to at least substantially mix the first material, the second material, and the conductive carbon until the dry mix is generally consistent. The method 100 may then move to block 106.

Block 106 depicts wet mixing a polymer including a polyvinylidene fluoride (PVDF) (e.g., 1%-8%) in N-methyl-2-pyrrolidone (NMP) to form a first wet mix. The polymer including a polyvinylidene fluoride (PVDF) in N-methyl-2-pyrrolidone (NMP) may be mixed using a wet mixer (e.g., a tank with a ribbon blender) until a first wet mix with a general consistency is formed. In one example, the NMP includes TUBALL™ BATT 0.4% NMP suspension (available from OCSiAl, Gahanna, Ohio) and 2% PVDF. The method 100 may then move to block 108.

Block 108 depicts wet mixing polyvinylidene fluoride (PVDF), multi-walled carbon nanotubes (MWCNT), and N-methyl-2-pyrrolidone (NMP) to form a second wet mix. The polyvinylidene fluoride (PVDF), multi-walled carbon nanotubes (MWCNT), and N-methyl-2-pyrrolidone (NMP) may be mixed using a wet mixer (e.g., a tank with a ribbon blender) until a second wet mix with a general consistency is formed. The method 100 may then move to block 110.

Block 110 depicts wet mixing the first wet mix with the second wet mix to form a third wet mix. Wet mixing the first wet mix with the second wet mix may be performed by adding the first wet mix to the second wet mix using, for example, a wet mixer (e.g., a tank with a ribbon blender) to form a third wet mix with a generally consistent texture and viscosity. The method 100 may then move to block 112.

Block 112 depicts mixing the dry mix with the third wet mix to form a slurry, wherein the slurry has a solid content of 50% or greater, or preferably 55% or greater. A reference solid content range can be 50% to 70%. The dry mix may be mixed with the third wet mix using, for example, a tank with a ribbon blender until the slurry is formed with a consistent texture and little or no clusters of solids. The third wet mix can include at least one of a binder or a carbon suspension. The method 100 then moves to block 114.

Block 114 depicts coating the lithium iron phosphate (LFP) cathode 26 with the slurry. Coating the lithium iron phosphate (LFP) cathode 26 may include using various deposition techniques, for example chemical vapor deposition. Coating the lithium iron phosphate (LFP) cathode 26 may include coating one or multiple sides of the cathode 26. The method then moves to block 116.

Block 116 depicts drying the lithium iron phosphate (LFP) cathode 26. Drying the cathode 26 may include using a dryer until the slurry and resulting coating 36 is at least substantially dry. The method 100 then moves to block 118.

Block 118 depicts calendering the lithium iron phosphate (LFP) cathode 26. Calendering the cathode 26 may include passing the cathode 26 and coating 36 between rollers at elevated temperatures to compact and homogenize the cathode 26 and coating 36. Calendering the cathode 26 decreases electrode porosity, increases the electrode density and volumetric energy density of the LFP battery 20.

In some instances, and shown at block 120, the method 100 may include adding N-methyl-2-pyrrolidone (NMP) to the slurry prior to coating the LFP cathode 26. Adding the NMP can be performed to adjust the overall solid content of the slurry.

The LFP battery 20 of the present disclosure is advantageous and beneficial over prior art LFP batteries or other lithium batteries. Compared with current NCM (lithium nickel cobalt manganese) cathodes, the LFP cathode 26 exhibits good thermal stability but has a lower specific capacity. The LFP cathode 26 disclosed herein addresses these issues by including the coating 36 with multiple sets of particles size distribution on the LFP cathode 26 combined with the lithium anode 28 and the reduced electrolyte viscosity. This combination increases energy density and exhibits good thermal behavior by providing high loading (e.g., 4 mAh/cm²), low porosity (e.g., 25%-30%), and high density (e.g., 1.8-2.4 g/cm³).

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A lithium iron phosphate battery, comprising:
a lithium iron phosphate (LFP) cathode having a coating is adhered to the lithium iron phosphate cathode, wherein the coating includes a first material more than 70% by weight, wherein the first material has a mean particle size (D50) of 10 μm, and includes a second material less than 30% by weight, wherein the second material has a mean particle size (D50) of 1 μm;
a lithium anode; and
a liquid electrolyte that transports positively charged ions between the lithium anode and the LFP cathode, wherein the liquid electrolyte includes between 1.0 and 1.5 M LiPF6 and between 0 and 0.5 M LiFSI.

2. The lithium iron phosphate battery of claim 1, wherein the lithium iron phosphate cathode thickness range is 80-120 μm.

3. The lithium iron phosphate battery of claim 1, wherein the lithium iron phosphate cathode has a loading greater than 4.0 mAh/cm².

4. The lithium iron phosphate battery of claim 1, wherein the lithium iron phosphate cathode has a porosity in a range of 25%-30%.

5. The lithium iron phosphate battery of claim 1, wherein the first material is lithium iron phosphate powder.

6. The lithium iron phosphate battery of claim 1, wherein the second material is lithium iron phosphate powder.

7. The lithium iron phosphate battery of claim 1, wherein the lithium anode having a thickness between 5-60 μm.

8. The lithium iron phosphate battery of claim 1, wherein the liquid electrolyte has a viscosity in a range of 0.3-1.3 centipoise.

9. The lithium iron phosphate battery of claim 1, wherein the liquid electrolyte includes a cyclic carbonate between 10% and 50% by weight.

10. The lithium iron phosphate battery of claim 9, wherein the cyclic carbonate includes at least one of ethylene carbonate, fluoroethylene carbonate, difluoro ethylene carbonate, or 3,3,3-trifluoropropylene carbonate.

11. The lithium iron phosphate battery of claim 1, wherein the liquid electrolyte includes at least one of acyclic acetate, propionate, or butyrate between 10% and 90% by weight.

12. The lithium iron phosphate battery of claim 1, wherein the liquid electrolyte comprises at least one of methyl acetate, ethyl acetate, methyl propionate, ethyl propionate, methyl butyrate, methyl butyrate, or ethyl butyrate.

13. A method for producing a lithium iron phosphate battery, comprising:
determining a coating formulation for a lithium iron phosphate (LFP) cathode, wherein the coating formulation includes a first material more than 70% by weight, wherein the first material has a mean particle size (D50) of 10 μm, and a second material less than 30% by weight, wherein the second material has a mean particle size (D50) of 1 μm;
mixing a slurry including the coating formation and at least one of a binder or a carbon suspension, wherein the slurry has a solid content of 55% or greater;
coating the LFP cathode with the slurry;
drying the LFP cathode and the slurry to form a coating; and
calendering the LFP cathode and the coating.

14. The method of claim 13, wherein the lithium iron phosphate cathode thickness range is 80-120 μm.

15. The method of claim 13, wherein the lithium iron phosphate cathode has a loading greater than 4.0 mAh/cm².

16. The method of claim 13, wherein the lithium iron phosphate cathode has a porosity in a range of 25%-30%.

17. The method of claim 13, wherein the first material is lithium iron phosphate powder.

18. The method of claim 13, wherein the second material is lithium iron phosphate powder.

19. A method for producing a lithium iron phosphate battery, comprising:
determining a coating formulation for a lithium iron phosphate (LFP) cathode, wherein the coating formulation includes a first material having lithium iron phosphate powder more than 70% by weight, wherein the first material has a mean particle size of 10 μm, and includes a second material less than 30% by weight, wherein the second material includes lithium iron phosphate powder and has a mean particle size of 1 μm;
dry mixing the first material, the second material, and conductive carbon to form a dry mix;
wet mixing a polymer including polyvinylidene fluoride (PVDF) in N-methyl-2-pyrrolidone (NMP) to form a first wet mix;
wet mixing polyvinylidene fluoride (PVDF), multi-walled carbon nanotubes (MWCNT), and N-methyl-2-pyrrolidone (NMP) to form a second wet mix;
wet mixing the first wet mix with the second wet mix to form a third wet mix;
mixing the dry mix with the third wet mix to form a slurry, wherein the slurry has a solid content of 55% or greater;
coating the lithium iron phosphate (LFP) cathode with the slurry;
drying the lithium iron phosphate (LFP) cathode; and
calendering the lithium iron phosphate (LFP) cathode.

20. The method of claim 19, further comprising:
adding N-methyl-2-pyrrolidone (NMP) to the slurry.
